(19) United States
(12) Patent Application Publication
(10) Pub. No.: US 2009/0167786 A1
(43) Pub. Date: Jul. 2, 2009

(54) METHODS AND APPARATUS FOR ASSOCIATING IMAGE DATA

(76) Inventors: Ronald Stanions, Callahan, FL (US); William D. Meadow, Jacksonville, FL (US); Matthew Pavelle, Jacksonville, FL (US)

Correspondence Address: Joseph P. Kincart;Ideation Law, 8153 Middle Fork Way, Jacksonville, FL, 32256, US

(21) Appl. No.: 12/343,942

(22) Filed: Dec. 24, 2008

Related U.S. Application Data
(60) Provisional application No. 61/009,147, filed on Dec. 24, 2007.

(51) Int. Cl. G09G 5/00

(52) U.S. Cl. 345/630

(57) ABSTRACT

The present invention provides methods and apparatus for uniquely identifying multiple real estate parcels and integrating image data sourced from disparate image data capture devices. Disparate image data capture device can gather data from proximate locations viewing different directions. In addition, multiple continuums of image data can be virtually traverse by a user to emulate the human visual experience.

### CROSS REFERENCE TO RELATED APPLICATIONS

The present application claims priority to pending patent application Ser. No. 12/135,170, filed, Jun. 6, 2008 and entitled, “Apparatus and Method for Producing Video Drive-By Data Corresponding to a Geographic Location,” the contents of which are relied upon and incorporated by reference, and also Provisional Patent Application Ser. No. 61/009,147 and entitled Methods and Apparatus for Associating Image Data filed Dec. 24, 2007, the contents of which are relied upon and incorporated by reference.

### FIELD OF THE INVENTION

The present invention relates to methods and apparatus for associating disparate image data related to a subject, and in particular, continuums of image data related to real estate.

### BACKGROUND OF THE INVENTION

Image recorders have been used to capture various views of a geographic location and in numerous formats. Photographs, movie cameras, video camera recorders, and more recently digital recorders have all been utilized to capture images of a geographic location, such as a real estate parcel. More recently, aerial views of a geographic location have been generated from aircraft, satellites and the like. Each format is distinct, in both its method of capture and its association with data descriptive of a particular image.

Generally, such methods of capturing image data and subsequently displaying such image data are useful for viewing various aspects of a chosen location. Each format may be useful for a distinct purpose not necessarily conducive to other formats, and data associated with one format may or may not be meaningful to an image captured in another format.

In some instances, more than one camera has been used to capture image data of a particular subject. Similarly, in other instances, one camera has been used to capture multiple images of a particular subject. However, methods of integrating the captured images have remained disjointed and not emulated the human experience of sight.

### SUMMARY OF THE INVENTION

Accordingly, the present invention provides methods and apparatus for uniquely identifying multiple real estate parcels and integrating image data sourced from disparate image data capture devices. Preferred embodiments include the disparate image data capture devices gathering data from proximate locations viewing different directions. In addition, the present invention provides apparatus and methods for virtually traversing multiple continuums of image data with each continuum integrated to emulate the human visual experience.

In some embodiments, the apparatus anticipates future requests for image data and prepares for the presentation of such data. In another aspect, the present invention provides a first modality of image data which provides for relatively high speed traversal of one or more continuums of image data at a relatively low image resolution. Apparatus will automatically transition to additional modalities with higher resolution image data and relatively low speed traversal of the data.

Some specific embodiments provide for selection between continuums of two-dimensional or three dimensional image data, wherein each continuum includes image data captured from a street level perspective.

Embodiments can therefore include apparatus, methods and stored instructions to facilitate processing information related to the integration of multiple sources of image data, as well as a method for interacting with a network access device to implement various inventive aspects of the present invention.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

As presented herein, various embodiments of the present invention will be described, followed by some specific examples of various components that can be utilized to implement the embodiments. The following drawings facilitate the description of some embodiments:

FIG. 1 illustrates an exemplary camera array for capturing multiple image continuums.

FIG. 2 illustrates an alignment of image data screens.

FIG. 3 illustrates a presentation of a compilation of disparate image data and a user control mechanism for traversing the disparate image data.

FIG. 4 illustrates a compilation of disparate image data and image download indicator and controls.

FIG. 5 illustrates configurations of image data capture.

FIG. 6 illustrates a block diagram of low resolution and higher resolution downloads.

FIG. 7 illustrates a flow chart of steps of related to resolution of downloads.

FIG. 8 illustrates apparatus that may be used to implement some embodiments of the present invention.

### DETAILED DESCRIPTION

The present invention provides methods and apparatus for generating and managing disparate compilations of image data. Disparate image data may be associated with a spatial designation, such as, for example a real estate location.

According to the present invention, image data capture device can gather data from proximate locations viewing different directions. In addition, multiple continuums of image data can be virtually traverse by a user to emulate the human visual experience. Image Data Capture Devices (IDCDs) capture disparate image data of a subject matter. At least a portion of image data captured by a given IDCD relates to overlapping subject matter with a portion of image data captured by another IDCD. The disparate image data related to the overlapping subject matter is integrated to present an aggregated view of data related to the subject.

In some preferred embodiments, multiple IDCDs point in various directions from a centric point. The various directions in which the IDCDs point can be generally coplanar or directed at different altitudes from the centric point.

In various embodiments of the present invention, the integrated image data may be viewed as a streaming continuum of image data; or as a horizontal, vertical or combination therein arc view of image data from a point of view comprising a spatial designation. The arc view can include up to a 360° arc, essentially emulating a human experience of standing at a location, at a particular moment in time and turning around. A spatial designation can include any mechanism defining a location and according to some embodiments of the present invention, each spatial designation can be uniquely associated with a UUID.

Another aspect of the present invention includes apparatus and methods for disseminating and viewing the integrated image data. An image data server can transmit integrated image data related to a particular spatial designation to a user interactive device and automatically generate and transmit additional image data in anticipation of a user's next request for image data.

### DEFINITIONS

As used herein, “Flash Viewer” (Streaming Video) refers to direct streaming of video to an online user via a web browser.

As used herein, “Image Data Capture Device” or “IDCD” refers to an apparatus capable of capturing image data of a spatial designation. An example of an Image Capture Device includes a digital camera with a lens appropriate for a predetermined spatial designation.

As used herein, a “Modality” refers to a mode of image data including: a) the capture of image data from a unique perspective in relation to a subject captured in the image data, as compared to other modes; or b) the presentation of image data from a unique perspective in relation to the subject matter captured in the image data as compared to other modes.

As used herein, “Video DriveBy™” Modality refers to a presentation modality of street level image data captured in multiple angles, and in some embodiments encompassing a 360° view.

As used herein, “RibbonView™” refers to a two dimensional continuum of image data with filmstrip like view of properties, which provides direct-on front images of a subject to be displayed.

As used herein, a “UUID” refers to a universally unique identifier and is an identifier standard associated with software implementations and standardized by the Open Software Foundation (“OSF”) as part of the Distributing Computing Environment (“DCE”). Some exemplary embodiments of UUIDs include globally unique identifiers (GUIDs) from Microsoft.

As used herein, “Video FlyBy™” refers to Aerial/Satellite oblique (angular) view image data with polygon line views.

As used herein, “Virtual Walkabout™” refers to a virtual mode of accessing image data which emulates walking through a scene presented. Preferred embodiments include walking through a scene created by spraying actual image data over three-dimensional models generated based upon the image data.

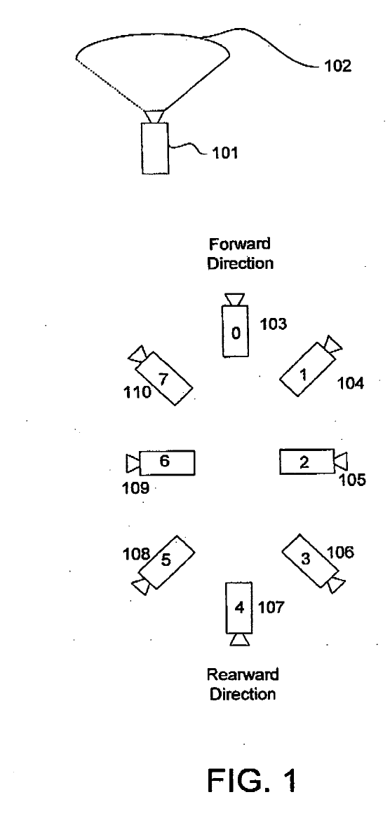

Referring now to FIG. 1, IDCDs 101A-B are illustrated. Each IDCD is associated with a relative spatial designation 102A-B from which the IDCD is capable of capturing image data. An arrangement 100 of multiple IDCDs 0-7 can be arranged to capture image data from different directions 103-110 and function as disparate sources of image data. In some embodiments, IDCDs 0-7 can be secured in a generally planar manner and positioned to capture generally planar image data. Alignment of captured image data from respective spatial designations 102 may take place without artificial delay, or via post processing.

Some embodiments include reference to disparate IDCDs wherein each IDCD may include an entire self contained unit with a lens system capable of receiving image data from a designated spatial designation and dedicated image data processing capability; or each IDCD may include a lens system capable of receiving image data from a designated spatial designation and centralized image data processing capability. The centralized image data processing capability being operative to process image data received into multiple lens systems while keeping image data received into each lens system separate from other image data. In some instances, captured image data can include data received from laser assisted radar (“LADAR”) or other data that facilitates processing of three dimensional distances and features.

Multiple IDCDs located proximate to each other can capture image data during a designated time period and be time stamped to correlate data received from each IDCD. In addition, in some embodiments, the IDCDs can be arranged to capture data during contiguous instances of time as if from a single point of view X. The point of view may, for example, be concentric, from an oblong configuration, or from a polygon configuration.

In some embodiments, a respective spatial designation 102 for a camera 0-7 may be positioned at a given location to overlap with a respective spatial designation 102 of an adjacent camera 0-7. Embodiments where multiple cameras are positioned to capture data from a single point of view can include the simultaneous capture of image data in a horizontal, vertical or combination thereof arc of up to 360°. According to some embodiments of the present invention, each spatial designation may be associated with a UUID. Other variables may also be associated with a UUID, such as, for example, the location from which spatial designations were determined or individual or multiple frames of image data.

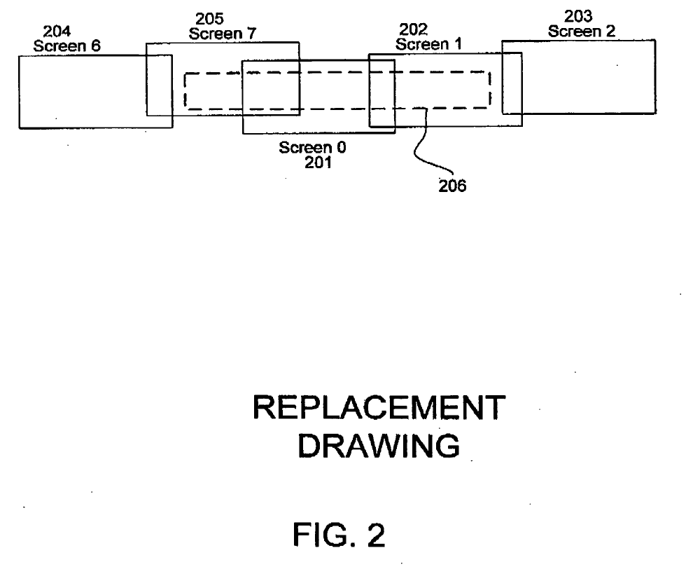

Referring now to FIG. 2, according to the present invention, image data correlating with adjacent disparate IDCDs 0-7 is presented on adjacent portions of one or more display portions 201-205. As discussed above, such image data captured from disparate IDCDs 0-7 correlates with respective spatial designations 102. Coordinates are calculated for aligning image data from adjacent portions. Alignment can be accomplished, for example, according to common features present in the respective portions 201-205 of image data, wherein the features are ascertained via known pattern recognition techniques. As recognized patterns are ascertained along border portions of adjacent images, the images may be adjusted in a vertical and horizontal dimension to align the patterns.

Alignment of image data captured by a first IDCD 0-7 and an adjacent second IDCD 0-7 may compensate for any physical factor responsible for misalignment of adjacent first and second IDCDs 0-7 utilized to capture the image respective portions of image data 201-205. Physical factors may include, for example, irregularities of a mounting surface to which the IDCDs are mounted, a slope in a roadway from which the image data is captured, an irregular road surface or other factor.

According to the present invention, a composite image portion 206 is composed of two or more aligned display portions 201-205. Included in the alignment is an overlay area 207-208 that is used to blend a first image portion 201-205 with a second image portion 201-205. In some embodiments, blending can include combining some pixels of data from a first image portion 201-205 with pixels of data from a second image portion 201-205. Some embodiments can also include modification of an overlapping pixel of data according to the colors of the overlapping pixels, still other embodiments can include standardized mechanisms, such as an Alpha blending mechanism of computer graphics programming.

As illustrated, the composite image portion 206 spans across aligned image data comprising Screen 0 201, Screen 1 202 and Screen 7 205. In some respects, the aligned image portion 206 emulates a field of view of a person viewing an area captured in the image data, with binocular or greater sources of image data combined into a single composite image portion 206.

According to some embodiments, a user computing device will request image data correlating with, or descriptive of, a spatial designation. The user computing device includes any apparatus with a display capable of producing an image in human recognizable form. Typically, the user computing device will also include a processor and a digital storage apparatus. A computer server will download image data to the user computing device. The downloaded data will have been stored on the server from multiple IDCDs which simultaneously captured image data associated with the spatial designation. The downloaded image data will include the captured image data that is included in a composite image portion 206. The downloaded data can also include coordinates for downloaded aligning image data that was captured from the multiple disparate IDCDs 0-7.

As discussed above, data available for downloading generally includes a 360° view captured simultaneously from a given point of view. In some preferred embodiments, a field of view is specified by a user. For example, a user may input a subject that the user desires to view. The subject may include, by way of example, a home at a specified address. Relevant image data can be identified that includes image data descriptive of the subject. The identified image data will typically include a 360 degree view of a location of the subject. Image data first downloaded will include a field of view that includes the subject. A field of view may include, for example a 135° field of view that includes the subject. The field of view image data will download first, along with the alignment coordinates and a user computing device will construct a field of view image based upon the downloaded image data and the alignment coordinates. Once all field of view image data has been downloaded, additional image data sets that are included in a 360° composite of the subject location can continue to download (sometimes referred to as “backfilled image data”). Still further downloaded data can include image data of adjacent subject matter. Additional data can anticipate a user request to view adjacent fields of view.

By way of example, a 135 degree field of view can initially be requested by a user of a particular subject area, such as a real estate parcel. Responsive to the request, a server containing image data can download sets of image data from multiple IDCDs 0-7 that include image data of the subject area. In addition, coordinates can also be downloaded which facilitate alignment of the image data sets from the disparate IDCDs 0-7. After the initial 135° field of view has been downloaded, additional fields of view may also be downloaded.

Some additional embodiments can include an image of a map of a general area including the subject area. An avatar, or a virtual vehicle can travel the map according to the subject area currently displayed as a composite image. Other embodiments can include an aerial view and an indictor on the aerial view as to which subject area is currently displayed as a composite image. Still other embodiments can include selecting a point on a map or an aerial view and viewing composite image data of the selected point, wherein the point acts as an indicator of the subject matter.

In another aspect, a high resolution imagery of a subject area can automatically download when a virtual vehicle or avatar used to travel a map or aerial view, virtually stops at a location. For example, when the avatar stops on a map and a low resolution 360° view of the subject area located by the avatar has competed downloading to the user computing device, the server can automatically begin to transmit to the user computing device high resolution data of the subject area. In addition, some embodiments can include a visual indication of a virtual vehicle or avatar location on the map or aerial view.

In still another aspect, a view presented to a user can auto-track a property as a virtual vehicle is moved in virtual proximity to a subject property. For example, a 135° degree view, or any user view described herein, can stay focused upon a subject property as a perspective for the view of the subject property is changed according to the virtual location of the virtual vehicle. In this respect, a Video DriveBy can be replayed according to the relative view from the virtual vehicle.

Referring now to FIG. 2A, according to some embodiments of the present invention, image data correlating with a single IDCD 0-7 and taken at multiple instances of time can be presented as adjacent overlapped images 211-215. Each portion of image data 211-215 corresponds with a spatial designation 102 of the IDCD 0-7 used to capture the image data 211-215. Coordinates are calculated for aligning image data from disparate portions, each taken at different instances of time. Alignment can be accomplished, for example, according to common features present in the respective portions 211-215 of image data, wherein the features are ascertained via known pattern recognition techniques. As recognized patterns are ascertained along border portions of disparate images, the images may be adjusted in a vertical and horizontal dimension to align the patterns.

Alignment of image data captured by the IDCD 0-7 at a first instance and at a second instance may compensate for any physical factor responsible for misalignment of the IDCD 0-7 during the first instance as compared to a second instance. Physical factors may include, for example, irregularities of a road surface over which the IDCD is traveling, a slope in a roadway from which the image data is captured or other factor.

As used in the discussion of these embodiments, a first instance and a second instance can be a first time t1 and a second time t2 with some time period differential between t1 and t2.

According to some embodiments of the present invention, a composite image portion 216 can be composed of two or more aligned display portions 211-215. An overlay area 217-218 can be used to blend a first image portion 211-215 with a second image portion 211-215. In some embodiments, blending can include combining some pixels of data from a first image portion 211-215 with pixels of data from a second image portion 211-215. Some embodiments can also include modification of an overlapping pixel of data according to the colors of the overlapping pixels, still other embodiments can include standardized mechanisms, such as an Alpha blending mechanism of computer graphics programming.

According to some embodiments, a user computing device will request image data correlating with, or descriptive of, a spatial designation. The user computing device includes any apparatus with a display capable of producing an image in human recognizable form. Typically, the user computing device will also include a processor and a digital storage apparatus. A computer server will download image data to the user computing device. The downloaded data will have been stored on the server from multiple IDCDs which captured image data associated with the spatial designation over multiple instances of time. The downloaded image data will include the captured image data that is included in a composite image portion 216. The downloaded data can also include coordinates for aligning downloaded image data that was during the multiple instances of time.

Data available for downloading form a single IDCD 0-7 over multiple instances of time generally includes a planar view of a subject area. In some preferred embodiments, a user may input a subject that the user desires to view. The subject may include, by way of example, a home at a specified address. Relevant image data can be identified that includes image data descriptive of the subject over multiple instances of time. Image data first downloaded will include a field of view that includes the subject. Image data can be downloaded, along with alignment coordinates, such that a user computing device can construct a field of view image based upon the downloaded image data and the alignment coordinates. Once all field of view image data has been downloaded, additional image data sets, such as image data of subject matter in near proximity to downloaded data can also be download (sometimes referred to as “backfilled image data”). Still further downloaded data can include image data of adjacent subject matter. Additional data can anticipate a user request to view adjacent fields of view.

Some additional embodiments can include an image of a map of a general area including the subject area. An avatar, or a virtual vehicle, can travel the map according to the subject area currently displayed as a composite image. Other embodiments can include an aerial view and an indictor on the aerial view as to which subject area is currently displayed as a composite image. Still other embodiments can include selecting a point on a map or an aerial view and viewing composite image data of the selected point, wherein the point acts as an indicator of the subject matter.

In another aspect, a high resolution imagery of a subject area can automatically download when a virtual vehicle or avatar used to travel a map or aerial view, virtually stops at a location. For example, when the avatar stops on a map and a low resolution view of the subject area located by the avatar has competed downloading to the user computing device, the server can automatically begin to transmit to the user computing device high resolution data of the subject area. In addition, some embodiments can include a visual indication of a virtual vehicle or avatar location on the map or aerial view.

In still another aspect, a view presented to a user can auto-track a property as a virtual vehicle is moved in virtual proximity to a subject property. For example, a 135° degree view, or any user view described herein, can stay focused upon a subject property as a perspective for the view of the subject property is changed according to the virtual location of the virtual vehicle. In this respect, a Video DriveBy can be replayed according to the relative view from the virtual vehicle.

Therefore, as described in relation to FIGS. 2 and 2A, according to various embodiments of the present invention, alpha blending techniques can be applied one or both of image data sets captured from multiple IDCDs 0-7 at a single instance of time or to image data sets captured from a single IDCD 0-7 from multiple instances of time.

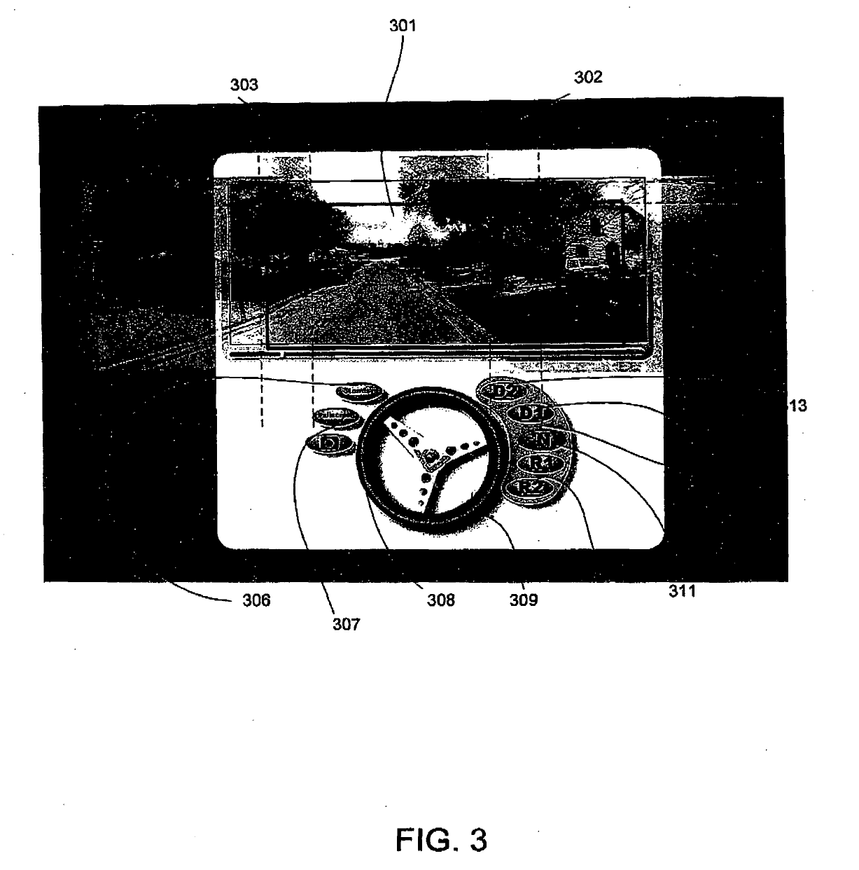

Referring now to FIG. 3, a user control mechanism 316 is illustrated according to some embodiments of the present invention. The control mechanism includes composite image data 300 aligned and blended, as discussed above, from three disparate image data portions 301-302. The composite image data 300 includes areas of blended image data 314-315. FIG. 3 additionally illustrates extraneous image data 304-305 beyond the boundary of the user control mechanism 300. The extraneous image data 304-305 is generally excluded from the control mechanism 300 during a data alignment process of data from the disparate image data portions 301-302 with the control mechanism superimposed over the composite image data 300.

The composite image data 300 also includes blended image data portions 314-315 which blend portions of first image data 301 with image data 302-303 aligned adjacent to the first image datum 301. For example, the blended image data portions 314-315 can include image data 301-303 blended using Alpha blending techniques.

The user control mechanism 316 can include one or more user interactive mechanisms 306-313 operative to control the display of the image data 300-303. The user interactive mechanisms 306-313 can include, for example, a virtual control to present a “standard view” of limited screen area and full composite image 300. A “full screen” virtual control 307 can present the full composite image 300 utilizing all display area available. Another virtual control 308 can be operative to present actual image data captured by an IDCD 0-7 sans any blending with adjacent image data. For example, the virtual control can be operative to cause the display of the actual image data captured by the IDCD, to be displayed on a frame by frame basis, at a predetermined or user determined rate, such as, for example: twelve (12) frames per second; twenty four (24) frames per second or twenty-nine point nine seven (29.97) frames per second.

A directional user interactive mechanism 309 can be used to control a virtual direction of “view” of image data. As illustrated, in some embodiments, the directional user interactive mechanism 309 can be presented in a form intuitive to most users, such as, for example, a virtual steering wheel. Other embodiments can include a virtual compass rose, joy stick, slide control or other device.

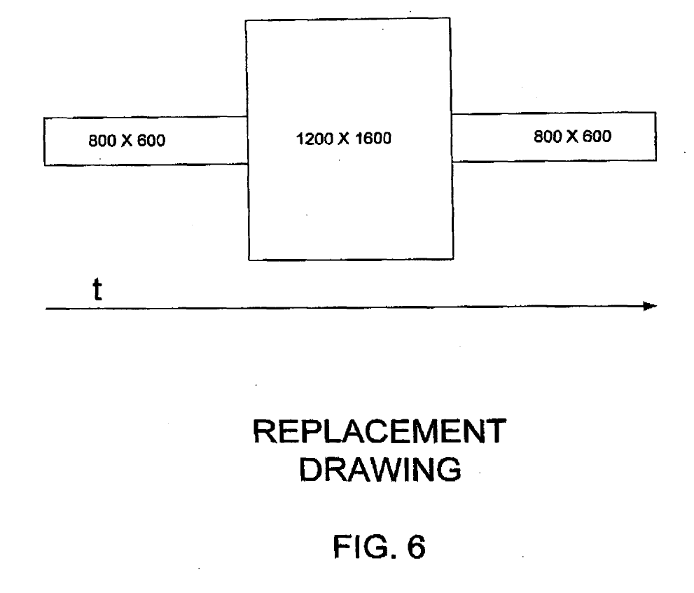

Still other interactive mechanisms 310-313 can include controls for a direction and speed of virtually traversing composite image data 300. As with other interactive mechanisms, a design and presentation can emulate animate controls that a user may be accustomed to, in order to facilitate understanding of the interactive mechanisms 310-313. For example, a D1 mechanism 312, can emulate a “Drive 1” position of an automobile shift pattern and a D2 mechanism 313 can emulate a “Drive 2” position. The D2 mechanism 313 can transverse the image data at a faster rate than the D1 mechanism 312. As discussed further below, with reference to FIG. 6, in some embodiments, a faster traversal of image data can be accomplished at a lower resolution than a slower traversal. Therefore, in some preferred embodiments, D2 mechanism 313 can be operative to down load image data at a lower resolution than a D1 mechanism 312.

An R1 mechanism 310 and an R2 mechanism 311 can operate in a fashion similar to the D1 mechanism 312 and D2 mechanism 313 but in a virtual direction of travel opposite to the D1 and D2 mechanisms 312-313.

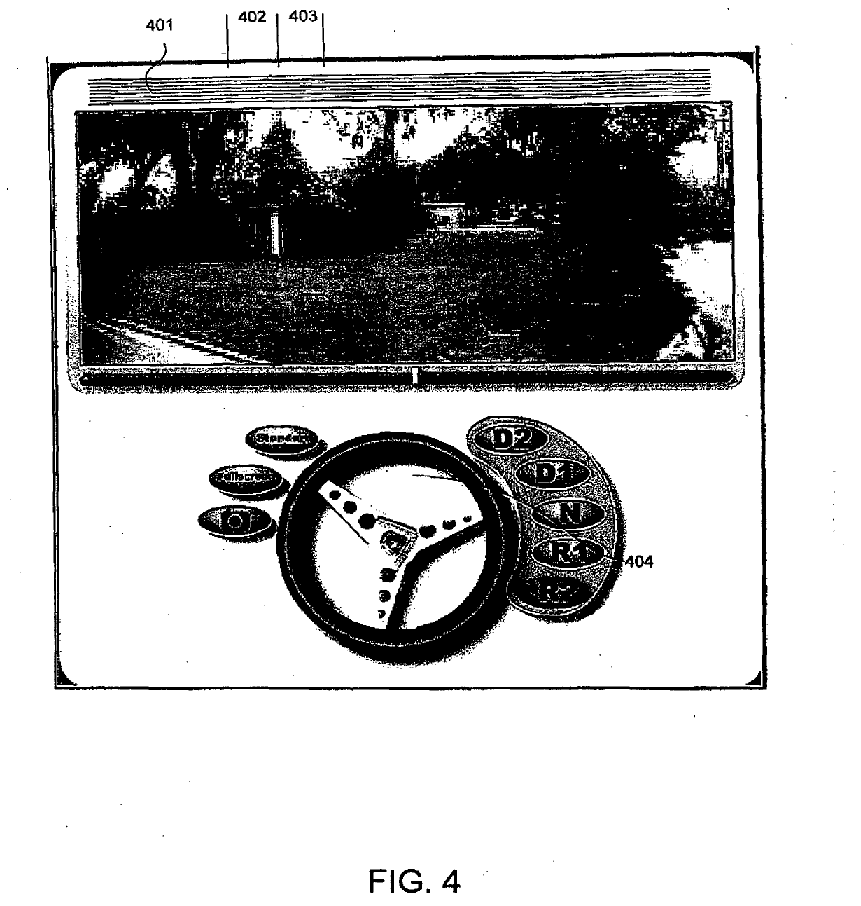

Referring now to FIG. 4, in some embodiments, a user interactive device 400 can include one or more available data mechanisms 401-403 can provide an indication of data that has been downloaded from one or more IDCDs 0-7.

A first mechanism can include a viewing mechanism 401 which provides a human readable form of image data. In some preferred embodiments, the human readable form of image data includes a composite of image data according to the description above for combining image data and an arc view of image data captured from a particular location, centric point or other designation. A second mechanism can include a slide control 402 for controlling a particular portion of image data to be displayed in the viewing mechanism 401.

Still another mechanism relates to disparate image datum from the multiple IDCDs 0-7 that are available for viewing. Limited bandwidth on a communications network, such as the Internet, typically results in delays when a user or routine requests additional data outside of the scope of data immediately available for viewing or other access. According to the present invention, a request for image data from a first data source, such as a first IDCD 0-7, initiates data downloading from additional data sources, such as other IDCDs 0-7 as well as additional data from the first IDCD 0-7. It should be noted that in some preferred embodiments, data from recorded from IDCDs 0-7 will be stored on a computer server, or array of servers. A request for image data will be received by the server and appropriate image data will be transmitted from the server to a requesting computing device. Accordingly, various embodiments may include one or both of requested data being downloaded from a computer server on which it is stored, or directly from a IDCD.

An image data download indicator 403, shown both in context in a user interactive device 400 and expanded in a blown up 400A. The download indicator 403 provides an indication 404A-404H of which image data has been downloaded in relation to particular IDCDs 0-7. As illustrated, each horizontal indicator 404A-404H correlates with a respective IDCD. In addition, multiple time periods 405-406 can be positioned in sequence for each IDCD indicator 404A-404H. A time period 405-406 can also be correlated with a UUID and a geographic location. For example, during a particular time period 405-406, a particular IDCD 0-7 was located at a particular location and captured image data of a particular spatial designation. Each variable can be associated to UUIDs and related to other variable UUIDs using well known data management mechanisms.

In another aspect, a user may provide a request to view data descriptive of a particular spatial designation which correlates with data captured by a particular IDCD at a particular time period. According to some embodiments of the present invention, a processor may execute software to determine an appropriate IDCD 0-7 and time period 405-406. The processor will download the requested data and then download additional data descriptive of close proximity to the requested data. For example, data in close proximity can include, data from IDCDs 0-7 capturing additional data in a contiguous arc of spatial designations, or additional geographic areas in linear proximity to geographic area requested, or additional data in a time sequence. Other related data is also within the scope of the present invention. In some embodiments, a user may specify a sequence of data download and in other embodiments, a predefined algorithm can be used to determine a sequence of data download.

According to the present invention, downloaded data can be graphically represented by a particular color or pattern and areas of data not downloaded can be graphically represented by a different color or pattern. In some embodiments, data queued to be downloaded can additionally be represented with a color or pattern indicating a download sequence. As illustrated, a sequence of data download 407 can be interrupted by subsequent request resulting in an additional data download sequence 404A-404H. However, an indication remains of previously downloaded data 407.

Although a particular embodiment is illustrated, a horizontal indicator 404A-404H, those skilled in the art will understand that other embodiments may include vertical indications, circular indications or other types of visual indicators.

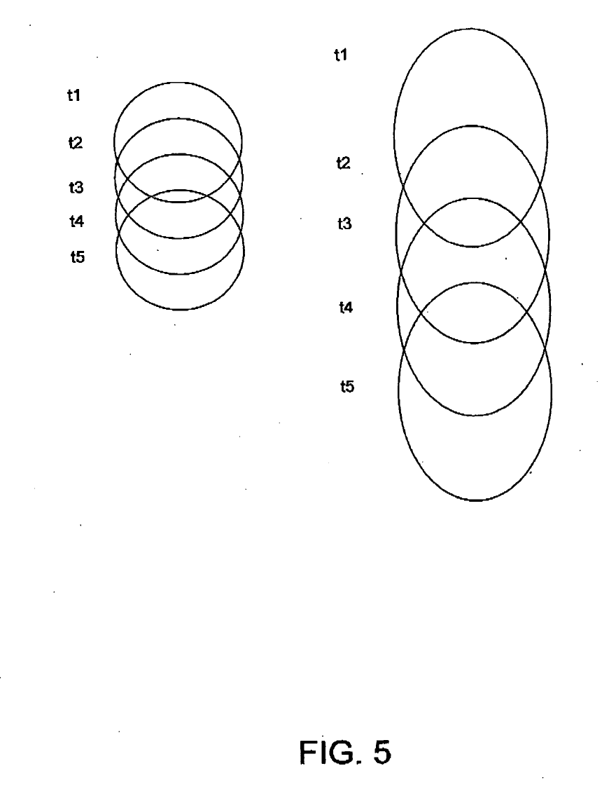

Referring now to FIG. 5, multiple IDCDs 0-7 may be arranged to capture various configurations of image data capture over one or more periods of time. As illustrated, times t1-t5 are associated with IDCDs arranged to capture a spherical pattern of image data from different positions for each instance of time t1-t5. This pattern would be emulated, for example, with a vehicle outfitted with IDCD positioned to capture data in relation to a centric point. The pattern associated with times t1a-t5a can be generated with IDCDs arranged to capture image data in an aspheric shape, oval shape, or other polygonal arrangement. Each time period t1-5 t1a-t5a can represent an instance in time during which image data was captured, in generally simultaneous image capture actions.

It should be noted, that other data, in addition to image data may also be captured during the time periods t1-t5 t1a-t5a. By way of non-limiting example, additional data may include, global positioning data, cell tower location data, grid location data, elevation data, directional data, LADAR data, WiFi or other data signal data, cellular reception data, noise level data, or other location specific data.

In another aspect of the present invention, according to some embodiments, image data 301 401 can be downloaded in a user viewable form in a first resolution during a first phase and a second resolution during a second phase.

For example, and referring now to FIG. 6, a user may request to view data associated with a particular real estate location. In response to the request, and beginning at t1 image data and metadata can be downloaded at a first resolution for the user's initial perusal. The low resolution 601 may be, for example 800×600 pixels. At t2, a second resolution of image data 602 may be downloaded, wherein the second resolution 602 includes a higher resolution, such as, 1600×1200 pixels. At t3, additional data may be downloaded at the lower resolution 601 again.

In some embodiments, a transition from a low resolution 601 to a second resolution 602 can be based upon an elapsed time period since a user has last requested new data.

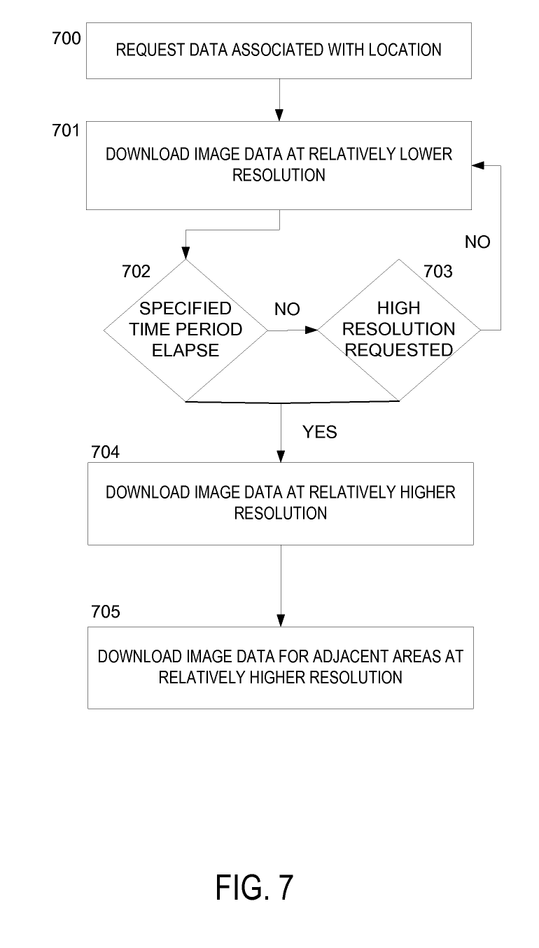

Referring now to FIG. 7, a flowchart illustrates steps that may be used to implement a transition from low resolution to high resolution data download. For example, at 701 a user requests data descriptive of a location, such as, for example: 10 Main Street, Yourtown USA. At 702 data is downloaded which includes image data at a first resolution 601, after a predetermined amount of elapsed time, such as, for example 15 seconds, if a request for data descriptive of a second location is not received during a predetermined elapsed time period, a processor may be programmed to automatically begin downloading data of 10 Main Street at a higher resolution 704. Additionally, and referring now to 703, if a user makes a direct request, or a series of events relevant to application usage takes place, higher resolution may be downloaded, even if the predetermined time period has not elapsed.

In addition, if a higher resolution download has completed for a requested location, high resolution downloads for adjacent areas can commence 705. In addition, if data descriptive of an additional location is requested, an elapsed time counter can be reset to begin again until an elapsed time period reaches the predetermined time period to begin download of high resolution data.

In various embodiments, a request for data related to a location can be input in various formats. By way of non-limiting example, an initial location may be designated according to one or more of: a street address, a tax map number, a grid designation, a GPS location or a latitude longitude coordinate. According to the present invention, once an initial location has been designated, a user control mechanism, such as those described above may be used to traverse data descriptive of additional locations in proximity to the initial location. In one particular example, a GPS location generated by a cellular phone may indicate where the cellular phone is located. The location of the phone may be used to download data descriptive of the phone location and also additional geographic areas in proximity to the location of the cellular phone. If a user dwells upon a particular location for an elapsed period of time which exceeds a predetermined amount of time, high resolution data may be automatically downloaded of an area being viewed as well as adjacent areas.

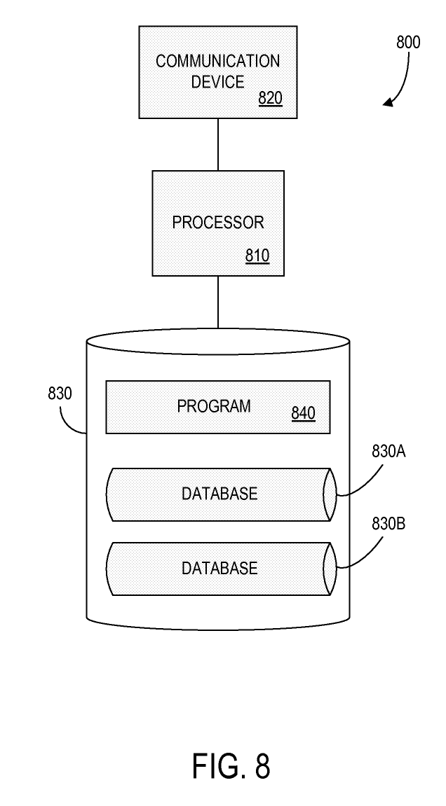

FIG. 8 illustrates a controller 800 that may be embodied in one or more of the above listed devices and utilized to implement some embodiments of the present invention. The controller 800 comprises a processor unit 810, such as one or more processors, coupled to a communication device 820 configured to communicate via a communication network (not shown in FIG. 8). The communication device 820 may be used to communicate, for example, with one or more online devices, such as a personal computer, laptop or a handheld device.

The processor 810 is also in communication with a storage device 830. The storage device 830 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

The storage device 830 can store a program 840 for controlling the processor 810. The processor 810 performs instructions of the program 840, and thereby operates in accordance with the present invention. The processor 810 may also cause the communication device 820 to transmit information, including, in some instances, control commands to operate apparatus to implement the processes described above.

Specific examples of apparatus utilized to implement various aspects of the invention can include a computer server, a personal computer, a laptop computer, a handheld computer, an iPod, a mobile phone or other communication device, or any other processor and display equipped device.

In some preferred embodiments, apparatus includes a video and data server farm. The video and data server farm includes at least one video storage server that stores video image files containing video drive-by data that corresponds to a geographic location, a database server that processes a data query received from a user over the Internet that corresponds to a geographic location of interest, and an image server. In operation, the database server identifies video image files stored in the video storage server that correspond to the geographic location of interest contained in the data query, and transfers the video image files over a pre-processing network to the image processing server. The image processing server converts the video drive-by data to post processed video data corresponding to a desired image format, and transfers the post processed video data via post-processing network to the Internet response to the query.

A landing zone server can also be included which receives the video drive-by data from a portable memory device and permits the viewing and analysis of the video drive-by data prior to storage in the video storage server. Still further, a map server is preferably provided to present a static image an overhead view of the geographic location of interest.

Embodiments can also include one or more servers described above included in one or more physical units. Each server does not need to be a disparate apparatus. Still other embodiments can include one or more or the servers described above included in multiple physical units. Some embodiments can even include a single server, as described which includes multiple physical apparatus units at disparate locations.

Those schooled in the art will also understand that although the above describes multiple disparate image capture devices, some embodiments can include a single apparatus with multiple disparate inputs to capture image data, wherein two or more inputs capture data from a distinct spatial designations.

### CONCLUSION

A number of embodiments of the present invention have been described. Nevertheless, it will be understood that various modifications may be made without departing from the spirit and scope of the invention. For example, various methods or equipment may be used to implement the process steps described herein or to create a device according to the inventive concepts provided above and further described in the claims. In addition, various integration of components, as well as software and firmware can be implemented. Accordingly, other embodiments are within the scope of the following claims.

1. An apparatus for processing data related to a location, the apparatus comprising:
a processor;
a storage device, said storage device storing disparate image data captured during a same time period from more than one image data capture device and at least a portion of image data captured by a given disparate image data capture device relates to overlapping subject matter with a portion of image data captured by another disparate image data capture device; and
executable software stored on the storage device and executable on demand, the software operative with the processor to cause the server to:
generate alignment coordinate data for facilitating alignment of image data in a vertical and a horizontal dimension, wherein the alignment coordinate data facilitates the formation of a composite image data portion comprising the alignment of image data captured by two or more image data capture devices during a same time period and designate a viewable area comprising a portion of the composite image data and communicate said viewable area to a human readable device.

2. The apparatus of claim 1 wherein the software is additionally operative to:
align image data captured by two or more image data capture devices during the same time period in a vertical and a horizontal dimension.

3. The apparatus of claim 1 wherein the software is additionally operative to:
form a composite image data portion comprising aligned image data captured by two or more image data capture devices during a same time period; designate a viewable area comprising a portion of the composite image data; and communicate said viewable area to a human readable device.

4. The apparatus of claim 3 wherein the image data captured by two or more image data capture devices during a same time period, is aligned based upon common features present in respective portions of image data captured by the respective image data capture devices.

5. The apparatus of claim 4 wherein overlapping portions of aligned image data are blended together.

6. The apparatus of claim 5 wherein the overlapping portions of aligned image data are blended with processes comprising alpha processing.

7. The apparatus of claim 1 wherein the software is additionally operative with the processor to transmit the image data and alignment coordinates to a user computing device.

8. The apparatus of claim 7 wherein the software is additionally operative with the processor to receive data descriptive of a first geographic location and transmit image data comprising the first geographic location and alignment coordinates for aligning the transmitted image data.

9. The apparatus of claim 8 wherein the software is additionally operative with the processor to automatically transmit image data and correlating alignment coordinates comprising an additional geographic location proximate to the first geographic location after the transmission of the image data of the first geographic location.

10. The apparatus of claim 8 wherein the transmitted image data comprising the first geographic location and alignment coordinates for aligning the transmitted image data comprises a first resolution and the software is additionally operative with the processor to transmit image data comprising the geographic location comprising a higher resolution than the first resolution.

11. The apparatus of claim 10 wherein image data comprising the higher resolution is automatically transmitted after a predetermined period of time has elapsed without a second receipt of data descriptive of a second geographic location.

12. The apparatus of claim 11 wherein image data comprising the higher resolution is transmitted based upon receipt of a request for higher resolution data.

13. An apparatus for generating a continuum of image data, the apparatus comprising:
three or more disparate image data capture devices secured in a position relative to the other image capture devices and positioned to capture image data of a respective spatial designation such that the spatial designation of each image data capture device overlaps a portion of the spatial designation of another image data capture device;
a data processing unit for receiving image data from multiple image capture devices with overlapping spatial designations and aligning the image data from the three or more disparate image data capture devices; and
a display apparatus operative to display the captured image data from the three or more image capture devices as a continuous image.

14. The apparatus of claim 13 wherein the spatial designation of each image data capture device overlaps a portion of the spatial designation of an adjacent image data capture device.

15. The apparatus of claim 14 wherein an aggregate of spatial designations comprises an arc.

16. The apparatus of claim 15, wherein the apparatus comprises eight image data capture devices and the arc comprises a 360° arc.

17. The apparatus of claim 15, wherein the continuous image comprises the captured image data aligned along a portion comprising the overlapping image data portions.

18. A method of creating a composite of image data, the method comprising:
transmitting a subject property designation;
receiving image data captured by disparate image data capture devices;
receiving alignment instructions for aligning image data comprising the image data captured by the disparate image data capture devices;
aligning the image data captured by the disparate image data capture devices based upon the instructions received; and
displaying a composite of image data comprising the aligned image data.

19. The method of claim 18 wherein the alignment instructions comprise coordinates for aligning the image data captured by disparate image data capture devices.

20. The method of claim 19 additionally comprising the steps of:
receiving image data captured by disparate image data capture devices in a first resolution;
displaying the composite of image data comprising the aligned image data in a first resolution;
receiving image data captured by disparate image data capture devices in a second resolution; and
displaying a second composite of image data comprising aligned image data in the second resolution.
